(19) United States
(12) Patent Application Publication
(10) Pub. No.: US 2024/0200620 A1
(43) Pub. Date: Jun. 20, 2024

(54) HANDHELD WORK APPARATUS WITH A BRAKE UNIT

(71) Applicant: Andreas Stihl AG & Co. KG, Waiblingen (DE)

(72) Inventors: Marcel Foerster, Schwaikheim (DE); Leonardo Batista, Waiblingen (DE); Tobias Freund, Ostfildern (DE); Michael-Armin Angerbauer, Ludwigsburg (DE)

(21) Appl. No.: 18/391,101

(22) Filed: Dec. 20, 2023

(30) Foreign Application Priority Data
Dec. 20, 2022 (DE) 10 2022 134 119.4

(51) Int. Cl. F16D 49/08

(52) U.S. Cl. CPC F16D 49/08

(57) ABSTRACT

A handheld work apparatus includes a tool and a brake unit for the tool. The brake unit includes a brake band and a brake drum. The brake band wraps around the brake drum. The brake unit is configured such that, during braking, a friction surface of the brake band is in contact with a friction surface of the brake drum, with the result that the brake band and the brake drum form friction partners. At least one of the friction surfaces is configured before a first braking operation on a wear layer, the thickness of the wear layer being from 0.5 μm to 3 μm or the thickness of the wear layer being from above 3 μm to 20 μm, and the wear layer containing Fe₂O₃ and/or FeO.

### CROSS-REFERENCE TO RELATED APPLICATIONS

This application claims priority of German patent application no. 10 2022 134 119.4, filed Dec. 20, 2022, the entire content of which is incorporated herein by reference.

### TECHNICAL FIELD

The disclosure relates to a handheld work apparatus with a brake unit.

### BACKGROUND

U.S. Pat. No. 4,949,818 discloses a handheld work apparatus, namely a motorized chain saw with a brake unit. In order to achieve sufficiently high service lives of the brake band, it is provided that the brake band is provided with a layer of oxide ceramic. The thickness of the friction layer should be approximately 100 μm here.

A work apparatus with a brake unit, the brake band of which has an edge layer, is apparent from US 2014/0291080. Carbon and/or nitrogen are/is diffused into the edge layer. This property right expresses the assumption that the atoms which are diffused into the edge layer diffuse further in the matrix toward the base body when the brake band is heated during the braking operation.

### SUMMARY

It is an object of the disclosure to provide a handheld work apparatus with a brake unit, wherein work apparatus has improved properties.

This object is, for example, achieved by a handheld work apparatus including: a tool; a brake unit for the tool; the brake unit including a brake band and a brake drum, the brake band being wrapped around the brake drum; the brake unit being configured such that, during braking, a band friction surface of the brake band is in contact with a drum friction surface of the brake drum such that the brake band and the brake drum form friction partners; and, wherein at least one of the drum friction surface and the band friction surface is formed, before a first braking operation, on a wear layer having a thickness from 0.5 micrometers to 3 micrometers.

The aforementioned object is, for example, also achieved by a handheld work apparatus including: a tool; a brake unit for the tool; the brake unit including a brake band and a brake drum, the brake band being wrapped around the brake drum; the brake unit being configured such that, during braking, a band friction surface of the brake band is in contact with a drum friction surface of the brake drum such that the brake band and the brake drum form friction partners; at least one of the band friction surface and the drum friction surface being configured, before a first braking operation, on a wear layer; and, the wear layer having a thickness above 3 micrometers to 50 micrometers and including at least one of Fe2O3 and FeO.

Brake units for handheld work apparatuses are subject to a series of boundary conditions. The coefficients of friction of the friction partners should lie within narrow bounds over the entire service life. The coefficients of friction change over the service life, however, with an increasing number of braking operations. It has been shown then that the tribological system of the two friction partners changes significantly during the first braking operations after the production of the work apparatus. Here, in particular, surface roughnesses are smoothed. As a result, the coefficient of friction between the friction partners decreases significantly.

According to the disclosure, it is provided in various embodiments that at least one of the friction surfaces is configured before a first braking operation on a wear layer. According to the disclosure, the wear layer has a comparatively low thickness of from 0.5 μm to 3 μm. During the first braking operations, the wear layer is subject to wear of at most 3 μm on account of its thickness. The wear layer therefore influences the coefficient of friction between the friction partners only over a part of the braking operations, preferably only over a few first braking operations. The wear layer is preferably present over at least 3, in particular approximately from 3 to 5 braking operations. After more than 5, in particular fewer than 10 braking operations, the wear layer can already be worn away, and a layer lying underneath of the brake band or brake drum forms the friction surface. The wear layer is preferably arranged on a base body of the associated friction partner, that is, on a base body of the brake drum and/or brake band. After wearing away of the wear layer, the base body which lies underneath advantageously forms the friction surface.

The wear layer brings it about that the tendency toward cold welding of the friction partners decreases during the first braking operations.

According to various embodiments, the wear layer contains Fe₂O₃ and/or FeO. The wear layer is preferably a mixed oxide layer which contains iron oxides.

It has been shown that, in particular in the case of brake drums with great diameters and/or in the case of great mass moments of inertia of the components to be braked including the tool, the wear layer can be worn away too rapidly. The wear layer can already be worn away, in particular, after at most 5 braking operations, in particular after at most 3 braking operations, in particular after fewer than 3 braking operations. It has been shown that a thickness of the wear layer of from above 3 μm to 50 μm, in particular from above 3 μm to 20 μm, in particular from above 3 μm to 10 μm, in particular from above 3 μm to 5 μm, results in advantageous braking times if the wear layer contains Fe₂O₃ and/or FeO.

The fact that the thickness of the wear layer is above 3 μm means that the thickness of the wear layer is more than 3 μm.

After the wear of the wear layer, the material of the wear layer is no longer present on the friction surface. The constituent parts of the wear layer are removed during the indicated first few braking operations, and are not incorporated or diffused into the base material.

The thickness of the wear layer from over 3 μm to 50 μm, in particular from over 3 μm to 20 μm, in particular from over 3 μm to 10 μm, in particular from over 3 μm to 5 μm, is provided, in particular, when the other one of the friction surfaces includes steel with the material number 1.4568 and/or steel with the material number 1.4419, in particular consists completely of steel with the material number 1.4568 and/or steel with the material number 1.4419.

According to various embodiments, the wear layer is not a coating, but rather a layer which has been produced by way of conversion, in particular oxidation, of the surface of the base body. The thickness of the wear layer is the oxidation depth here.

The wear layer can advantageously be a black oxide conversion layer. A black oxide conversion layer is, in particular, a burnished layer or a layer which is produced by way of a steam oxidation treatment.

The wear layer can particularly advantageously be a burnished layer, that is, a layer which has been produced by way of burnishing. According to DIN 50938 in the version of January 2018, a burnished layer is a thermally produced black oxide conversion layer which is produced by way of dipping into hot alkaline salt solutions. A two-bath burnishing method has proven to be particularly preferred. Production of the wear layer by way of a steam oxidation treatment (“steam treatment” in accordance with ASTM B935-16 in the version of Oct. 1, 2016) can also be provided.

The wear layer is in particular a burnished layer, in particular according to DIN 50938 in the version of January 2018, or a layer produced by way of a steam oxidation treatment (“steam treatment”), in particular in accordance with ASTM B935-16 in the version of Oct. 1, 2016

As an alternative, it is preferably provided that the wear layer contains phosphate. The wear layer is preferably a phosphate layer, a manganese phosphate layer, a zinc phosphate layer, an iron phosphate layer or a layer which contains a combination of phosphate, manganese phosphate, zinc phosphate and/or iron phosphate. Other compositions of wear layers can also be advantageous, however. The layer can be, for example, a boronized layer.

The friction surface of the brake drum particularly advantageously has the wear layer. In particular, in the case of a wear layer which is produced by way of burnishing, by way of a different dip method, by way of a steam oxidation treatment or by way of boronizing, it is advantageously provided that the entire brake drum has the wear layer.

The base body of the brake drum advantageously can include sintered steel. The base body of the brake drum particularly preferably includes sintered steel.

The base body of the brake band preferably includes stainless austenitic steel. The base body of the brake band particularly preferably consists of stainless austenitic steel.

In an embodiment, the austenitic steel of the base body of the brake band is heat-treated, in particular precipitation hardened. As an alternative or in addition, it can be provided that the base body of this friction partner includes spring steel, in particular steel with the material number 1.4568.

It is provided in an alternative embodiment that the base body of the brake band includes stainless martensitic steel. The base body of the brake band includes, in particular, martensitically hardened chromium steel. The base body of this friction partner preferably includes steel with the material numbers 1.4419, 1.4028, 1.4031, 1.4034 and/or 1.4037. According to various embodiments, the base body of this friction partner consists of one of the above-mentioned steels.

One friction partner advantageously does not have a wear layer. As a result, the work step of the production of the wear layer on this friction partner is dispensed with. It has been shown that a wear layer on one of the friction partners is advantageous to achieve a desired coefficient of friction.

The friction surface of the friction partner which does not have a wear layer is advantageously formed by way of the base body of this friction partner. Accordingly, the friction partner which does not have a wear layer with the stated, extremely low thickness does not have another coating or diffusion layer either. The averaged surface roughness R_{Z} of the friction surface of the friction partner which does not have a wear layer is advantageously at most 20 μm, in particular at most 10 μm, preferably from 5 μm to 7 μm before the first braking operation. In the present case, the averaged surface roughness R_{Z} is the averaged surface roughness R_{Z} according to DIN EN ISO 4287:1984.

The coefficient of friction between the friction surface of the brake drum and the friction surface of the brake band is advantageously from 0.1 to 0.35, in particular from 0.15 to 0.3. The stated coefficient of friction advantageously exists both during the first braking operations, in the case of which the wear layer forms the friction surface of one of the friction partners, and after the wear of the wear layer and, in particular, when the base body or base bodies of the brake drum and/or brake band forms/form the friction surfaces.

The averaged surface roughness R_{Z} of the friction surface of at least one friction partner which has the wear layer is advantageously at most 20 μm, in particular at most 10 μm, preferably from 5 μm to 7 μm before the first braking operation. It has been shown that an averaged surface roughness R_{Z} of the friction surface of at least one friction partner which has the wear layer of, in particular, from 3 μm to 5 μm can be advantageous before the first braking operation. Accordingly, the averaged surface roughness R_{Z} is advantageously lower than the thickness of the wear layer. During the first contact of the friction partners, the wear layer in the region of the elevations of the surface comes into contact with the other friction partner. These elevations are removed as a result, as a result of which the surface is smoothed and the actual surface, with which the friction partners are in contact, increases. The heat generated during the contact leads to it being possible for the surface to be oxidized in regions which no longer have a wear layer. It has been shown that, as a result, a wear layer with a thickness which is lower than the averaged surface roughness R_{Z} of the base material is sufficient to lower the coefficient of friction into the desired range during the first braking operations.

The averaged surface roughness R_{Z} can also be just as great as or greater than the thickness of the wear layer, in particular if the thickness of the wear layer is more than from 3 μm to 20 μm. A wear layer with a thickness which is approximately as great as or somewhat greater than the averaged surface roughness R_{Z} of the base material can also be sufficient, in particular, in order to lower the coefficient of friction into the desired range during the first braking operations. In particular, the averaged surface roughness R_{Z} is less than 5 times, in particular less than 2 times the thickness, in particular less than the thickness of the wear layer. In particular, a low averaged surface roughness R_{Z} is advantageous.

The work apparatus is, in particular, a chain saw or a cut-off machine. It can be provided that the work apparatus has a combustion engine for driving the tool. The work apparatus is particularly preferably a battery-operated work apparatus, however, which has an electric motor which is supplied with energy by a battery. In particular, the work apparatus is a battery-operated chain saw.

In the present case, the first braking operation is that braking operation, in the case of which the brake drum and the brake band come into contact with one another for the first time. The first braking operation can take place as early as the production of the work apparatus during functional tests.

### BRIEF DESCRIPTION OF DRAWINGS

The invention will now be described with reference to the drawings wherein:

FIG. 1 shows a diagrammatic, partially sectioned illustration of a chain saw which is driven by combustion engine;

FIG. 2 shows details of a diagrammatic illustration of the brake drum of the chain saw from FIG. 1;

FIG. 3 shows the detail III from FIG. 2 in a diagrammatic, greatly enlarged illustration;

FIG. 4 shows an illustration of the brake band of the chain saw from FIG. 1;

FIG. 5 shows a side view of a battery-operated chain saw; and,

FIG. 6 shows a side view of a battery-operated cut-off machine.

### DETAILED DESCRIPTION

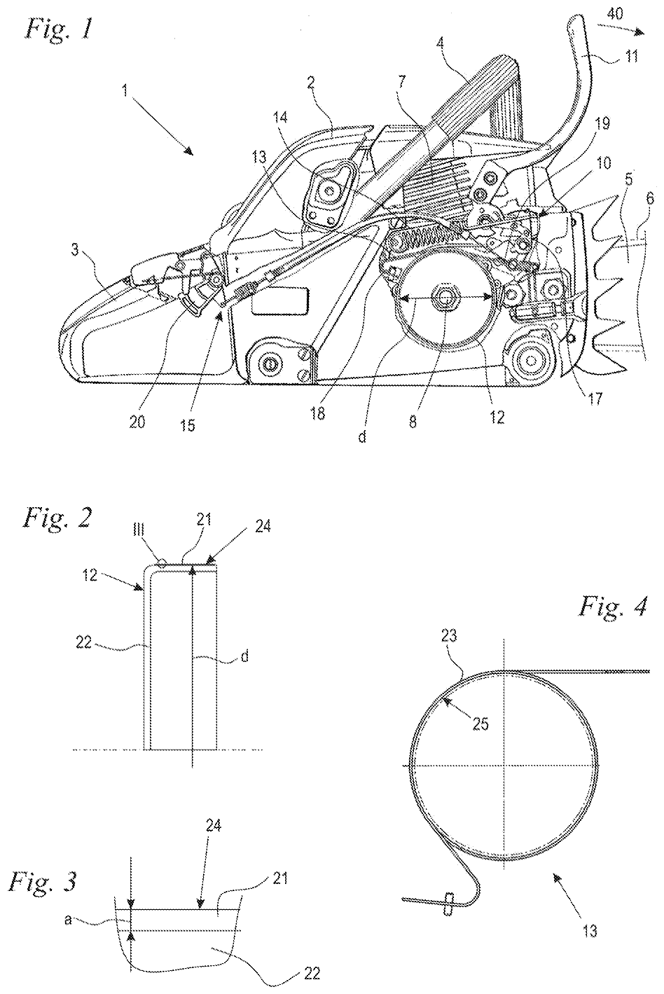

FIG. 1 shows a chain saw 1 as an embodiment for a handheld work apparatus. Instead of the chain saw 1, the handheld work apparatus can be a different handheld work apparatus such as, for example, a cut-off machine, a brushcutter, a soil drilling unit, a lawnmower or the like. The chain saw 1 has a housing 2, on which a rear handle 3 and a tubular handle 4 are held. The handheld work apparatus is guided at the handles by the operator during operation, and is advantageously carried by the operator.

The chain saw 1 has a guide bar 5, on which a saw chain 6 is arranged in a circulating manner. The saw chain 6 forms the tool of the chain saw 1. The saw chain 6 is driven during operation by a drive motor (in the embodiment by a combustion engine 7) in a circulating manner around the guide bar 5. The combustion engine 7 has a drive shaft 8. The drive shaft 8 is preferably a crankshaft of the combustion engine 7. The drive shaft 8 can be coupled to a brake drum 12. The brake drum 12 preferably carries a drive pinion (not shown in FIG. 1), with which the saw chain 6 is in engagement in a conventional way and which drives the saw chain 6. A different drive connection from the brake drum 12 to the tool can also be advantageous. The chain saw 1 has a hand protection 11. A brake unit 10 is provided in order to bring the saw chain 6 to a standstill. The hand protection 11 preferably serves to trigger the brake unit 10.

The brake unit 10 has a brake band 13 which wraps at least partially around the brake drum 12 on its outer circumference. The hand protection 11 acts via a toggle mechanism 17 on a triggering end 19 of the brake band 13. A fastening end 18 of the brake band 13 is fixed on the housing 2 in the embodiment. If the hand protection 11 is moved in the direction of the arrow 40, the toggle mechanism 17 is moved via its tilting point and is pulled by a spring 14 into the actuated position of the brake unit 10. Here, the brake band 13 is tightened around the brake drum 12.

In the case of the chain saw 1 which is shown in FIG. 1, moreover, a supplemental brake unit 15 is provided which likewise acts on the brake band 13 and which is connected to a hand throttle 20 of the chain saw 1.

A different configuration of the brake unit 10 can also be advantageous.

The brake drum 12 has a diameter d. The diameter d is the external diameter of the brake drum 12. The diameter d is measured in a region of the outer circumference of the brake drum 12, against which the brake band 13 bears. The diameter d is, in particular, more than 50 mm. In particular, the diameter d is at most 90 mm.

As FIG. 2 shows, the brake drum 12 includes a base body 22, on which a friction surface 24 is configured. The friction surface 24 is formed on the outer circumference of the brake drum 12. In the case of braking, the brake band 13 interacts with the brake drum 12 on the friction surface 24. The brake drum 12 has an inner surface 36. The inner surface 36 and the friction surface 24 are configured on opposite sides of a hollow-cylindrical portion of the brake drum 12. The brake drum 12 has a wear layer 21 on the friction surface 24 before the first braking operation. The wear layer 21 is of such thin configuration that it is preferably worn off during a number of first braking operations and is not present over the entire service life of the brake drum 12. The wear layer 21 is advantageously present over at least 3, in particular over from approximately 3 to 5 braking operations. After more than 5, in particular fewer than 10 braking operations, the wear layer 21 can already be worn off.

FIG. 3 diagrammatically shows the wear layer 21 on the base body 22. The wear layer 21 is shown as a separate layer in the illustration in FIG. 3. The wear layer 21 can be a layer which is applied on the base body 22 of the brake drum 12. It can particularly preferably be provided, however, that the wear layer 21 is an oxidation layer which is produced by way of conversion of the base material and not by way of application of a layer. The wear layer 21 is, in particular, a black oxide conversion layer. The wear layer 21 can be, for example, a burnished layer which has been produced by way of dipping into hot alkaline salt solutions. The burnished layer is a thermally produced black oxidic conversion layer. A different type of production of the wear layer can also be advantageous, however. The wear layer can be produced, for example, by way of a steam oxide treatment (“steam treatment” according to ASTM B935-16 in the version of Oct. 1, 2016). As an alternative, the wear layer can be a boronized layer.

The thickness a of the wear layer 21 is preferably very small. The thickness a is advantageously from 0.3 μm to 3 μm. The wear layer 21 advantageously can contain Fe₂O₃ and/or FeO. If the wear layer 21 contains Fe₂O₃ and/or FeO, the thickness a of the wear layer 21 can be, in an alternative embodiment, in particular from above 3 μm to 50 μm, in particular from above 3 μm to 20 μm, in particular from above 3 μm to 10 μm, in particular from above 3 μm to 5 μm. It can be provided that the wear layer 21 is a black oxidic conversion layer, in particular a burnished layer or a layer which is produced by way of a steam oxide treatment (“steam treatment”). It can also be provided that the wear layer 21 contains phosphate. The wear layer 21 can be, in particular, a phosphate layer, a manganese phosphate layer or a zinc phosphate layer.

The thickness a of the wear layer 21 is, in particular, at most 50 μm, in particular at most 20 μm, in particular at most 10 μm, in particular at most 5 μm.

The thickness a of the wear layer 21 is adapted, in particular, to the diameter d of the brake drum 12. The diameter d of the brake drum 12 is usually adapted to the forces to be transmitted. The higher the forces to be transmitted are, the greater, in particular, the diameter d of the brake drum 12 which is selected.

The thickness a of the wear layer 21 from above 3 μm to 50 μm, in particular from above 3 μm to 20 μm, in particular from above 3 μm to 10 μm, in particular from above 3 μm to 5 μm is provided, in particular, when the other one of the friction surfaces includes steel with the material number 1.4568 and/or steel with the material number 1.4419, in particular consists completely of steel with the material number 1.4568 and/or steel with the material number 1.4419.

FIG. 4 shows the brake band 13 of the embodiment. The brake band 13 has a base body 23, on the inner surface of which a friction surface 25 is configured. In the case of braking, the friction surfaces 24 and 25 of the brake drum 12 and brake band 13 come into frictional contact with one another and, as a result, brake the brake drum 12 as far as a standstill.

In the embodiment, the brake drum 12 carries the wear layer 21, and the brake band 13 does not carry any wear layer. In an alternative embodiment, it can be provided that the brake band 13 has a wear layer 21. In this case, the brake drum 12 can be configured without a wear layer 21. In a further alternative embodiment, both the brake band 13 and the brake drum 12 have a wear layer 21.

The brake drum 12 preferably has the wear layer 21.

The base body of the brake drum 12 advantageously includes sintered steel. The base body of the brake drum 12 preferably consists of sintered steel.

The brake brand 13 preferably does not have a wear layer 21. The base body 23 of the brake band 13 advantageously includes stainless austenitic steel. The base body 23 of the brake brand 13 preferably consists of stainless austenitic steel. The austenitic steel of the base body 23 of the brake band 13 is advantageously heat-treated, in particular precipitation hardened. The base body 23 of the brake band 13 advantageously consists of spring steel, in particular of spring steel with the material number 1.4568. It can be provided that the base body of the brake band 13 includes further components.

In an alternative design variant, the base body of the brake band 13 can include stainless martensitic steel, preferably martensitically hardened chromium steel. The base body of the brake band 13 particularly preferably includes steel with the material numbers 1.4419, 1.4028, 1.4031, 1.4034 and/or 1.4037.

If one friction partner does not have a wear layer 21, it is advantageously provided that the friction surface 24, 25 is formed by way of the base body 22, 23 of this friction partner.

The averaged surface roughness R_{Z} of the friction surfaces 24 and 25 of the brake drum 12 and brake band 13 is advantageously at most 20 μm, in particular at most 10 μm, preferably from 5 μm to 7 μm before the first braking operation. The coefficient of friction between the friction surface 24 of the brake drum 12 and the friction surface 25 of the brake band 13 is advantageously from 0.1 to 0.35, in particular from 0.15 to 0.3.

In particular, the averaged surface roughness R_{Z} is less than 5 times, in particular less than 2 times the thickness a of the wear layer 21. In particular, the averaged surface roughness R_{Z} is less than the thickness a of the wear layer 21. An averaged surface roughness R_{Z} which is less than the thickness a of the wear layer 21 is advantageous, in particular, when the thickness a of the wear layer 21 is more than 3 μm, in particular at least 5 μm, in particular at least 10 μm.

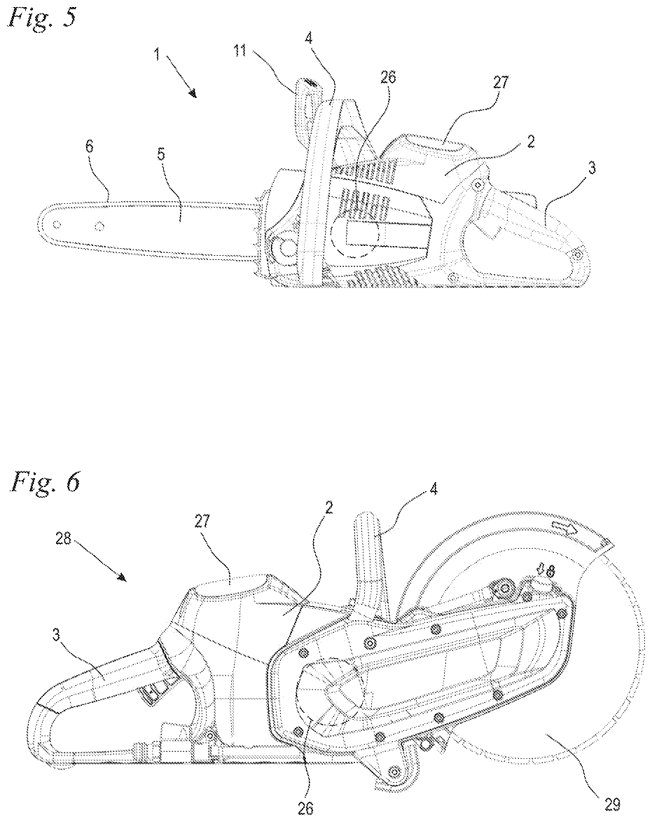

FIG. 5 shows a battery-operated chain saw 1 as an embodiment for a chain saw 1. An electric motor 26 which serves to drive the saw chain 6 is arranged in the housing 2 of the chain saw 1. The electric motor 26 is supplied with energy by a battery 27.

FIG. 6 shows a battery-operated cut-off machine 28 as an embodiment for a handheld work apparatus. The cut-off machine 28 includes the electric motor 26 which is supplied with energy by the battery 27. The tool of the cut-off machine 28 forms a cutting disk 29 which is driven rotationally by the electric motor 26 during operation.

A brake unit 10 in accordance with the brake unit 10 which is explained with respect to FIGS. 1 to 4 is arranged in the operative connection between the electric motor 26 and the saw chain 6 or cutting disk 29.

It is understood that the foregoing description is that of the preferred embodiments of the invention and that various changes and modifications may be made thereto without departing from the spirit and scope of the invention as defined in the appended claims.

1. A handheld work apparatus comprising:
a tool;
a brake unit for said tool;
said brake unit including a brake band and a brake drum, said brake band being wrapped around said brake drum;
said brake unit being configured such that, during braking, a band friction surface of said brake band is in contact with a drum friction surface of said brake drum such that said brake band and said brake drum form friction partners; and,
wherein at least one of said drum friction surface and said band friction surface is formed, before a first braking operation, on a wear layer having a thickness from 0.5 micrometers to 3 micrometers.

2. The work apparatus of claim 1, wherein said wear layer includes at least one of Fe₂O₃ and FeO.

3. The work apparatus of claim 1, wherein said wear layer includes phosphate.

4. The work apparatus of claim 1, wherein said drum friction surface has said wear layer; and, said brake drum has a base body which includes sintered steel.

5. The work apparatus of claim 1, wherein said brake band has a base body which includes spring steel.

6. The work apparatus of claim 1, wherein said brake band has a base body which includes stainless martensitic steel.

7. The work apparatus of claim 1, wherein at least one of said drum friction surface and said band friction surface has an averaged surface roughness which is at most 20 micrometers before the first braking operation.

8. The work apparatus of claim 1, wherein a coefficient of friction between said drum friction surface and said band friction surface is from 0.1 to 0.35.

9. A handheld work apparatus comprising:
a tool;
a brake unit for said tool;
said brake unit including a brake band and a brake drum, said brake band being wrapped around said brake drum;
said brake unit being configured such that, during braking, a band friction surface of said brake band is in contact with a drum friction surface of said brake drum such that said brake band and said brake drum form friction partners;
at least one of said band friction surface and said drum friction surface being configured, before a first braking operation, on a wear layer; and,
said wear layer having a thickness above 3 micrometers to 50 micrometers and including at least one of Fe₂O₃ and FeO.

10. The work apparatus of claim 9, wherein said wear layer includes phosphate.

11. The work apparatus of claim 9, wherein said drum friction surface has said wear layer; and, said brake drum has a base body which includes sintered steel.

12. The work apparatus of claim 9, wherein said brake band has a base body which includes spring steel.

13. The work apparatus of claim 9, wherein said brake band has a base body which includes stainless martensitic steel.

14. The work apparatus of claim 9, wherein at least one of said band friction surface and said drum friction surface has a averaged surface roughness of at most 20 micrometers before the first braking operation.

15. The work apparatus of claim 9, wherein a coefficient of friction between said drum friction surface and said band friction surface is from 0.1 to 0.35.
